(19) United States
(12) Patent Application Publication
(10) Pub. No.: US 2021/0190113 A1
(43) Pub. Date: Jun. 24, 2021

(54) PVC fittings with a flat surface

(71) Applicant: Clarke Richard Baker, DE LEON, TX (US)

(72) Inventor: Clarke Richard Baker, DE LEON, TX (US)

(21) Appl. No.: 16/723,288

(22) Filed: Dec. 20, 2019

(51) Int. Cl. F16B 12/40; A47B 47/04

(52) U.S. Cl. CPC F16B 12/40; F16B 2012/403; A47B 47/04

(57) ABSTRACT

These are standard PVC fittings with a flat surface to support shelving. These items can also have an outer edge, the thickness of the pipe itself, to keep shelves in their place. The walls and flat surface of these fittings are the same as normal PVC connectors with the same interior and exterior dimensions.

### BACKGROUND OF THE INVENTION

The concept of a method for building shelving units is well known in the art. These fittings will be used in conjunction with normal PVC pipe and designed by the user for the final project. They will have the same openings as a normal PVC fitting but with a flat surface to support a shelf or table top. The fittings can be put together in a variety of ways to build a desired table, stand or shelving unit. Each of these connectors can either be secured into place by solvent or can be used without solvent. When using without a solvent, they can be held together by installing holes and screws in the shelves that will hold the connectors in place.

### DESCRIPTION OF THE DRAWINGS

FIG. 1, Straight Connection—This can be used for connecting PVC together and creating a flat surface to rest shelving on. Figure A would be the Front view of the item, Figure B would be the Right-Side view of the item, Figure C would be the Top view of the item and Figure D will be the 3D view of the item.

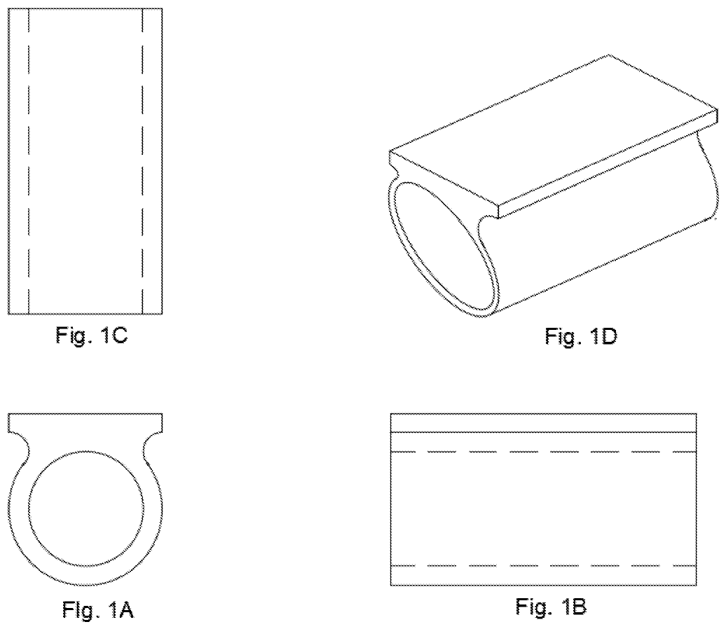

FIG. 2, End Cap, With Flat Surface—This can be used for the support of a shelf, foot of a stand or a wall mount. Figure A would be the Front view of the item, Figure B would be the Right-Side view of the item, Figure C would be the Top view of the item and Figure D will be the 3D view of the item.

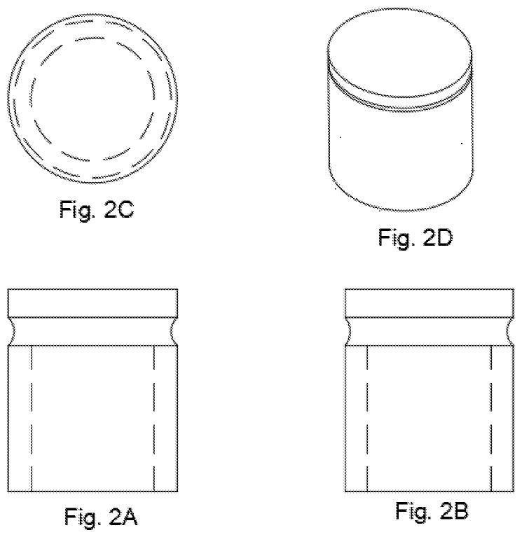

FIG. 3, Straight Connector w/Upper and Lower—This can be used for connecting PVC together and creating the in-line support of a shelf. An outer edge can also be used for the retaining of a shelf and can also have a flat or circular inner surface. Figure A would be the Front view of the item, Figure B would be the Right-Side view of the item, Figure C would be the Top view of the item and Figure D will be the 3D view of the item.

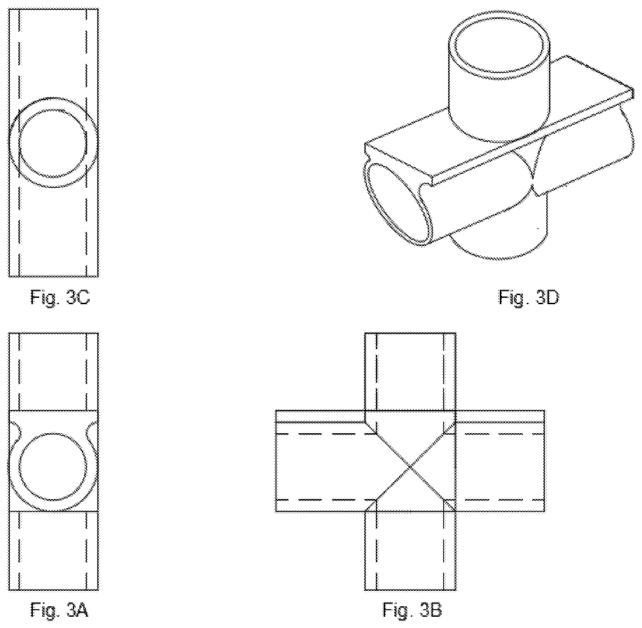

FIG. 4, Straight Connector w/Upper and Lower With a Tapered Surface—If a connector has an upper/lower, right/left or all for connecting PVC, the upper/lower, right/left outer surface can be tapered for creating a smoother connection. The start of the taper can be from any location along the wall of the PVC Connector. Figure A would be the Front view of the item, Figure B would be the Right-Side view of the item, Figure C would be the Top view of the item and Figure D will be the 3D view of the item.

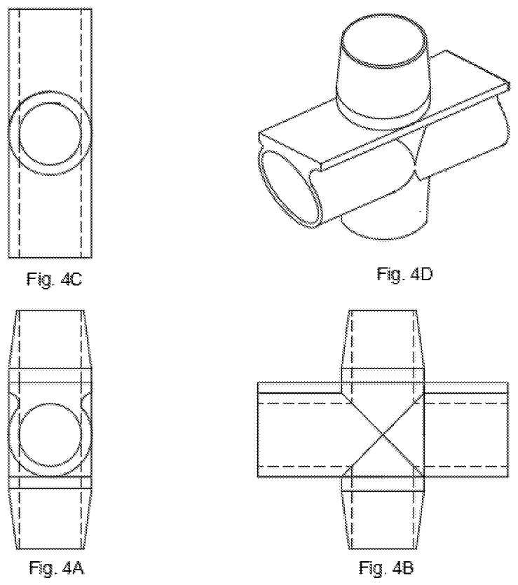

FIG. 5, 3 Way T w/Lower and Circular Edge—This can be used for connecting PVC together and creating the in-line support of a shelf. An outer edge can also be used for the retaining of a shelf and can also have a circular inner surface. Figure A would be the Front view of the item, Figure B would be the Right-Side view of the item, Figure C would be the Top view of the item and Figure D will be the 3D view of the item.

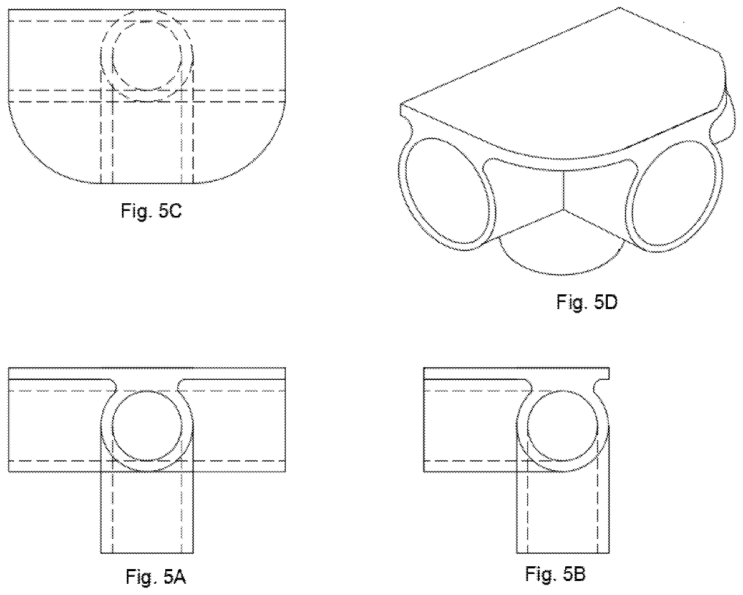

FIG. 6, 3 Way T w/Lower—This can be used for connecting PVC together and creating the in-line support of a shelf. An outer edge can also be used for the retaining of a shelf and can have a flat surface. Figure A would be the Front view of the item, Figure B would be the Right-Side view of the item, Figure C would be the Top view of the item and Figure D will be the 3D view of the item.

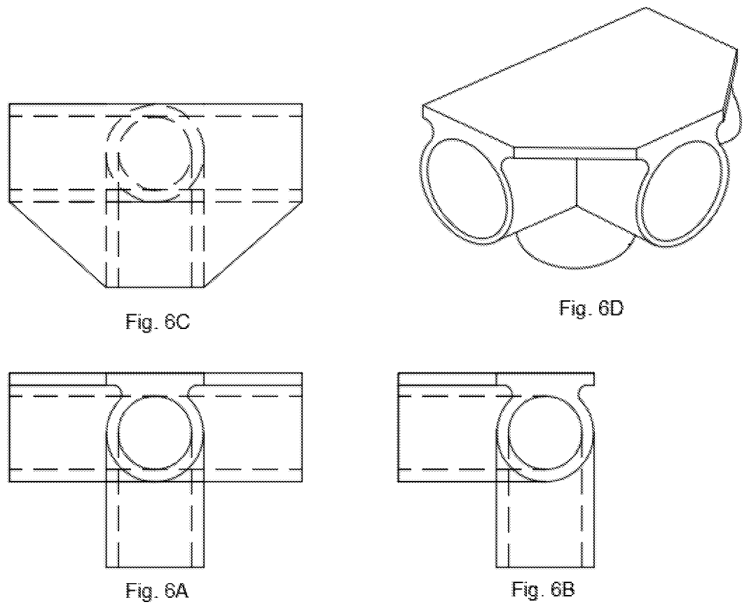

FIG. 7, 3 Way T, With Upper and Small Aligned Outer Edge—This can be used for connecting PVC together for creating support for a lower shelf of a unit. This connector can also have a small outer edge for holding shelves in place. Figure A would be the Front view of the item, Figure B would be the Right-Side view of the item, Figure C would be the Top view of the item and Figure D will be the 3D view of the item.

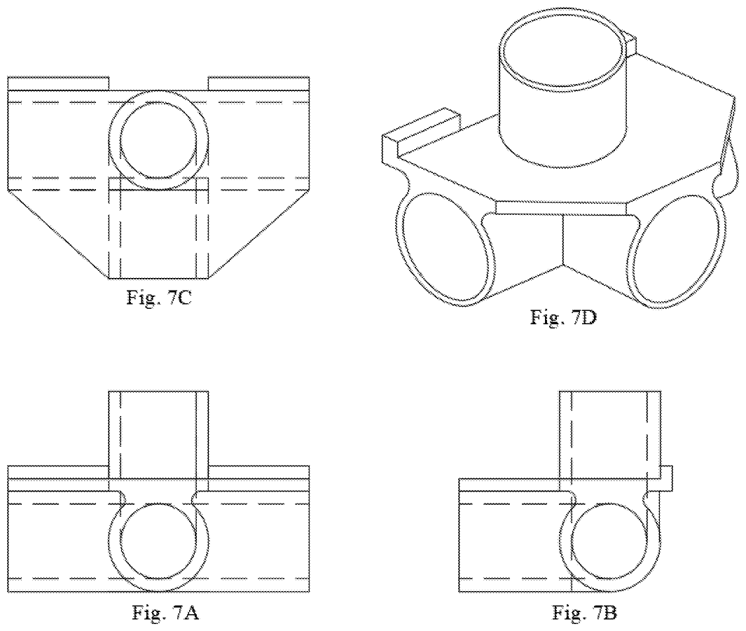

FIG. 8, 3 Way T, With Upper 90′ and Long Aligned Outer Edge—This can be used for connecting PVC together for creating support for a lower shelf of a unit and can be used as a foot. This connector can also have a flat or circular outer surface and a long aligned outer edge for holding shelves in place. Figure A would be the Front view of the item, Figure B would be the Right-Side view of the item, Figure C would be the Top view of the item and Figure D will be the 3D view of the item.

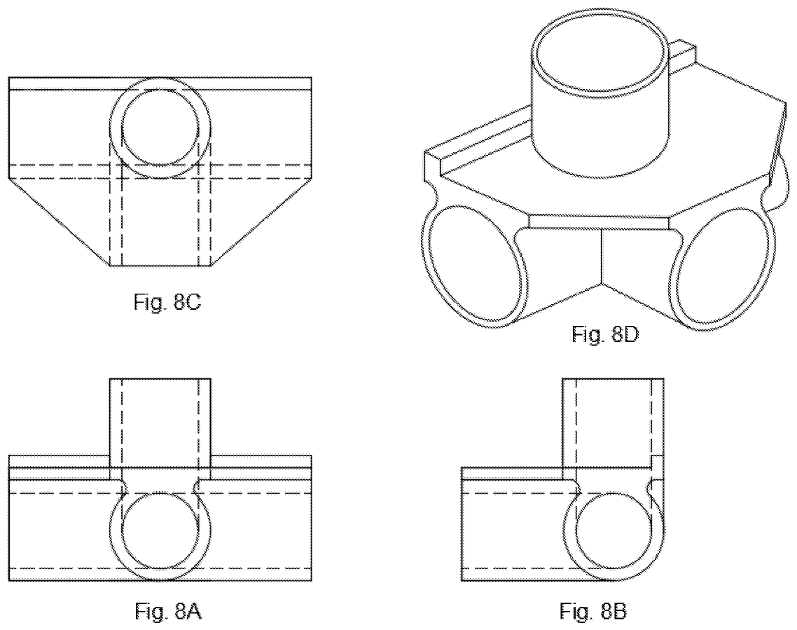

FIG. 9, 3 Way T, With Upper and Circular Edge—This can be used for connecting PVC together. Figure A would be the Front view of the item, Figure B would be the Right-Side view of the item, Figure C would be the Top view of the item and Figure D will be the 3D view of the item.

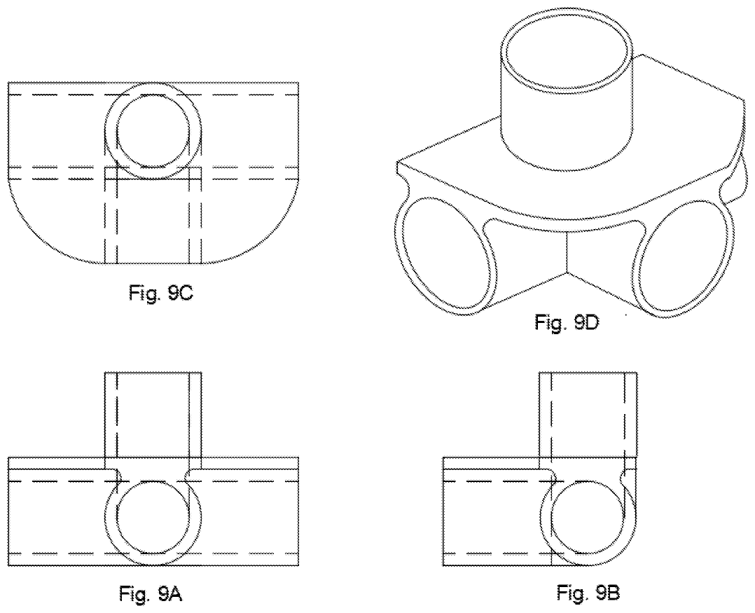

FIG. 10, 3 Way T, With Upper—This can be used for connecting PVC together and creating a corner foot or lower shelf for the unit. An outer edge can also be used for retaining a shelf. Figure A would be the Front view of the item, Figure B would be the Right-Side view of the item, Figure C would be the Top view of the item and Figure D will be the 3D view of the item.

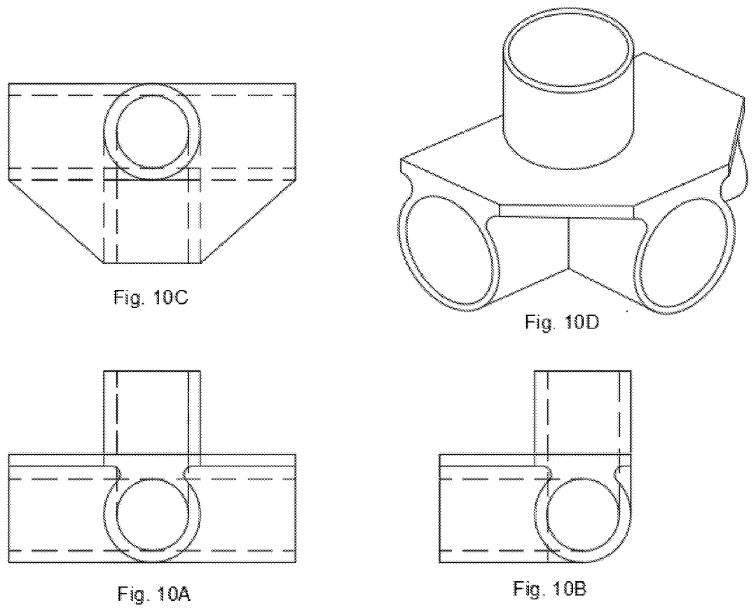

FIG. 11, 3 Way T, With Upper and Lower 90′, With Long Aligned Outer Edge—This can be used for connecting PVC together for creating an addition of a shelf on the outer edge of the unit. This connector can also have a flat or circular outer surface and an outer edge for holding shelves in place. Figure A would be the Front view of the item, Figure B would be the Right-Side view of the item, Figure C would be the Top view of the item and Figure D will be the 3D view of the item.

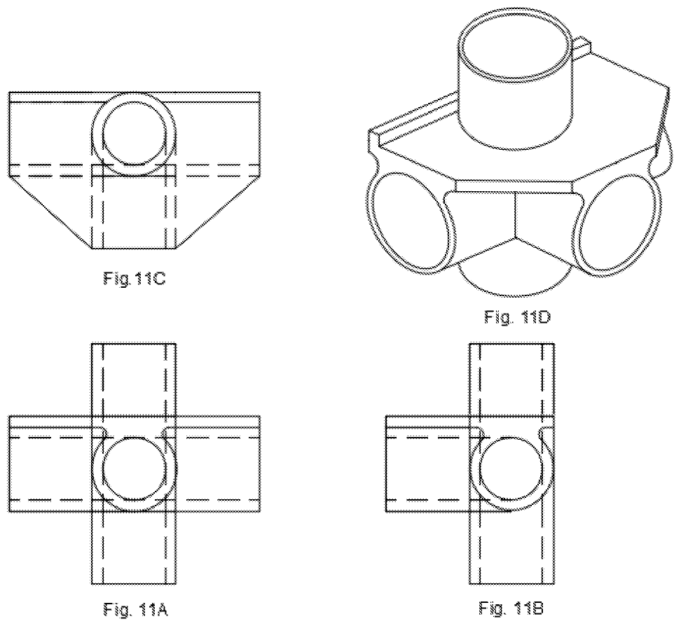

FIG. 12, 3 Way T, With Upper and Lower—This can be used for connecting PVC together and creating an addition of a shelf on the outer edge of the unit. Figure A would be the Front view of the item, Figure B would be the Right-Side view of the item, Figure C would be the Top view of the item and Figure D will be the 3D view of the item.

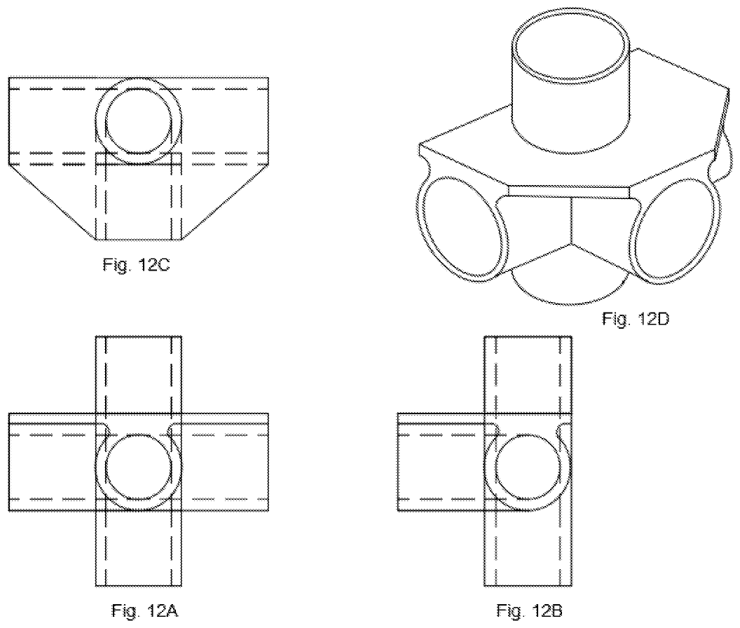

FIG. 13, 3 Way Y With Upper—This can be used for connecting PVC together and creating the in-line support of a shelf. This connector can also have a flat or circular outer surface. Figure A would be the Front view of the item, Figure B would be the Right-Side view of the item, Figure C would be the Top view of the item and Figure D will be the 3D view of the item.

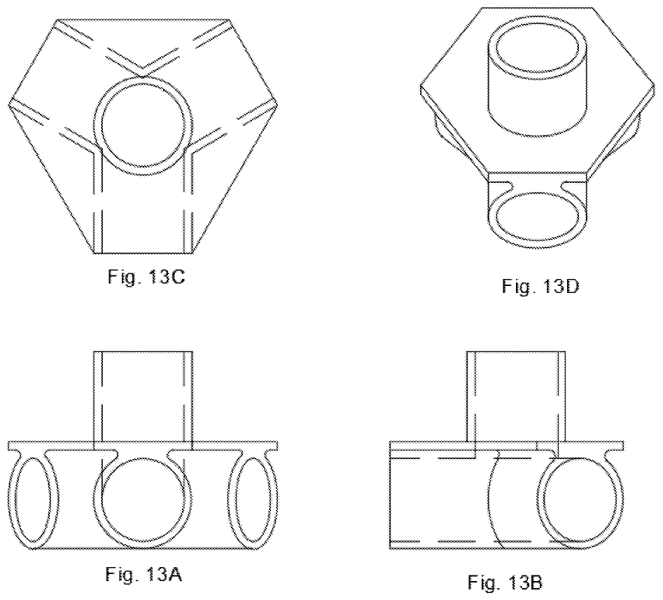

FIG. 14, 3 Way Y With Upper and Lower—This can be used for connecting PVC together and creating the in-line support of a shelf. This connector can also have a flat or circular outer surface. Figure A would be the Front view of the item, Figure B would be the Right-Side view of the item, Figure C would be the Top view of the item and Figure D will be the 3D view of the item.

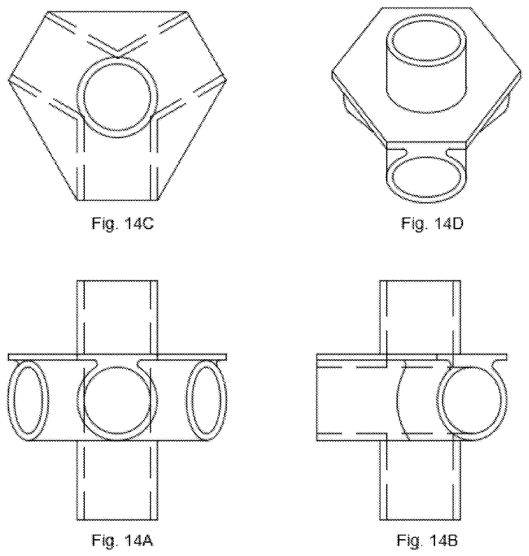

FIG. 15, 3 Way Y With Lower—This can be used for connecting PVC together and creating the in-line support of a shelf. This connector can also have a flat or circular outer surface. Figure A would be the Front view of the item, Figure B would be the Right-Side view of the item, Figure C would be the Top view of the item and Figure D will be the 3D view of the item.

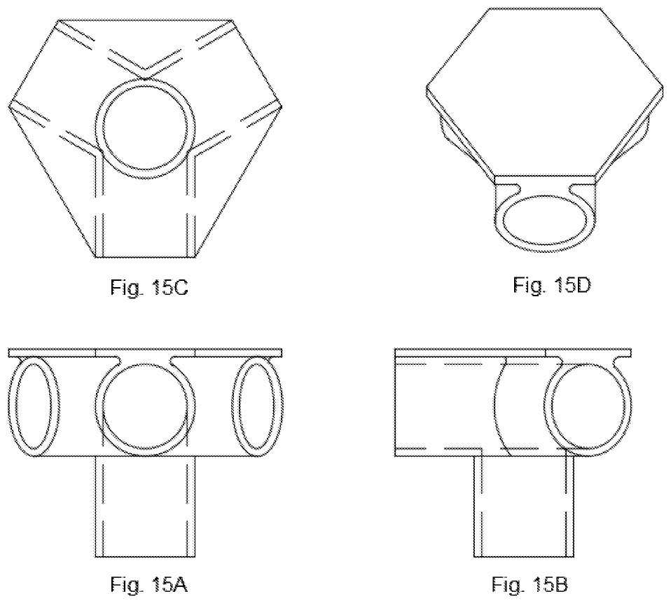

FIG. 16, 4 Way T With Lower—This can be used for connecting PVC together for creating support for an upper shelf of a unit or can be used upside down as a foot. This connector can also have a flat or circular outer surface. Figure A would be the Front view of the item, Figure B would be the Right-Side view of the item, Figure C would be the Top view of the item and Figure D will be the 3D view of the item.

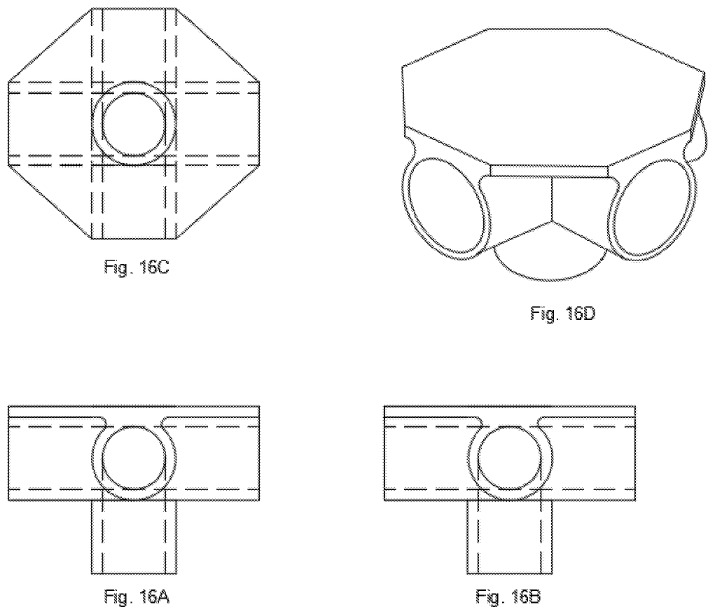

FIG. 17, 4 Way T With Upper—This can be used for connecting PVC together. This connector can also have a flat or circular outer surface. Figure A would be the Front view of the item, Figure B would be the Right-Side view of the item, Figure C would be the Top view of the item and Figure D will be the 3D view of the item.

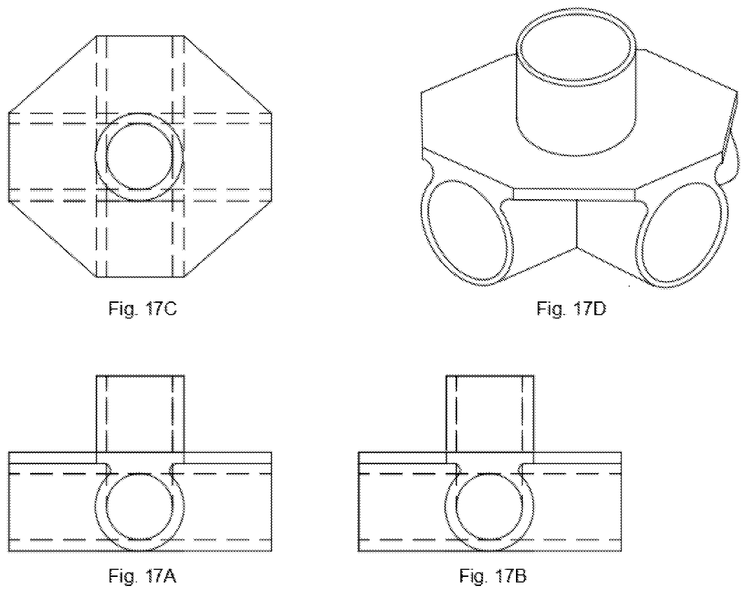

FIG. 18, 4 Way T w/Upper and Lower—This can be used for connecting PVC together and creating the in-line support of a shelf. This connector can also have a flat or circular outer surface. Figure A would be the Front view of the item, Figure B would be the Right-Side view of the item, Figure C would be the Top view of the item and Figure D will be the 3D view of the item.

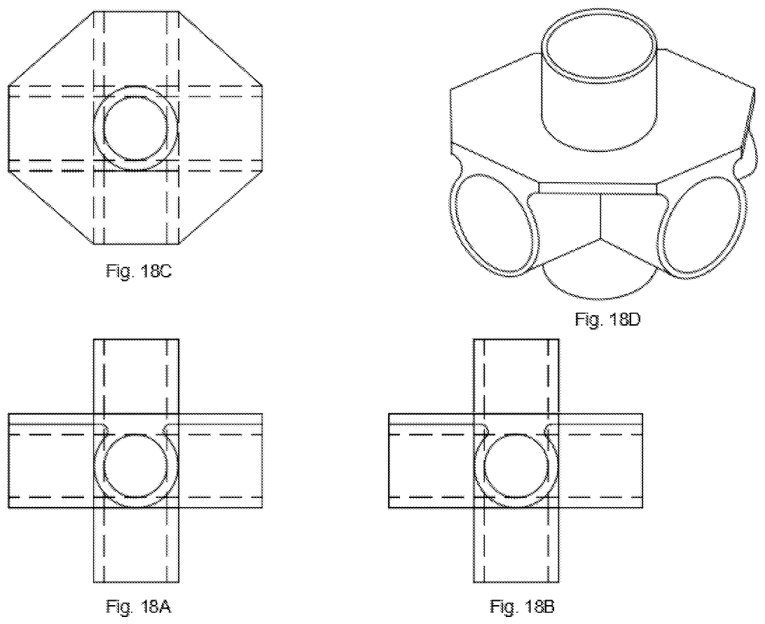

FIG. 19, 45′ Y—This right or left angle can be used for connecting PVC together and creating a cross section for the support of a shelf. Figure A would be the Front view of the item, Figure B would be the Right-Side view of the item, Figure C would be the Top view of the item and Figure D will be the 3D view of the item.

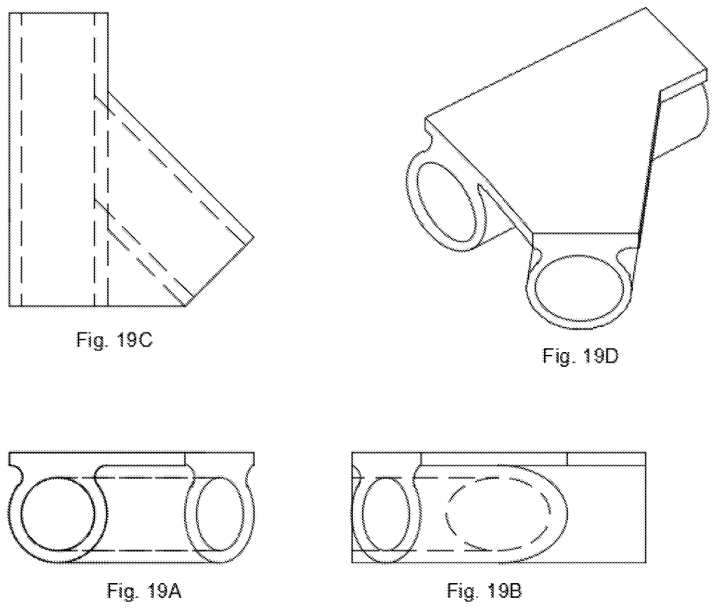

FIG. 20, 30′—Y, With Flat Side —This right or left angle can be used for connecting PVC together and creating a cross section for the support of a shelf. An outer edge can also be used for the retaining of a shelf. Figure A would be the Front view of the item, Figure B would be the Right-Side view of the item, Figure C would be the Top view of the item and Figure D will be the 3D view of the item.

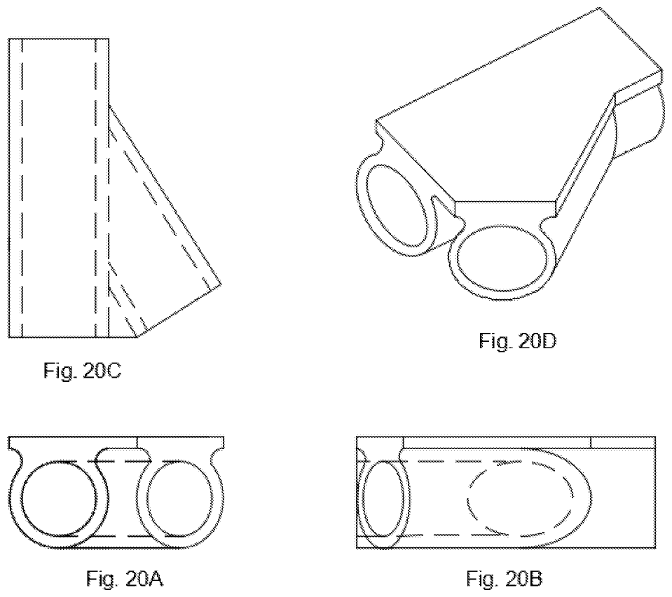

FIG. 21, 90′ With a Circular Edge—This can be used for connecting PVC together and creating a corner section or can be turned upside down for use as a foot for stabilization. An outer edge can also be used for the retaining of a shelf. Figure A would be the Front view of the item, Figure B would be the Right-Side view of the item, Figure C would be the Top view of the item and Figure D will be the 3D view of the item.

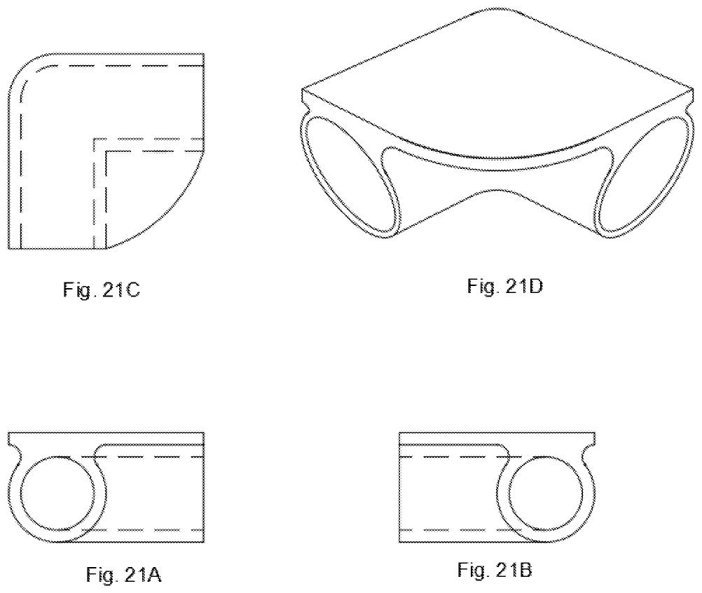

FIG. 22, 90′ With a Flat Edge—This can be used for connecting PVC together and creating a corner section or can be turned upside down for use as a foot for stabilization. An outer edge can also be used for the retaining of a shelf. Figure A would be the Front view of the item, Figure B would be the Right-Side view of the item, Figure C would be the Top view of the item and Figure D will be the 3D view of the item.

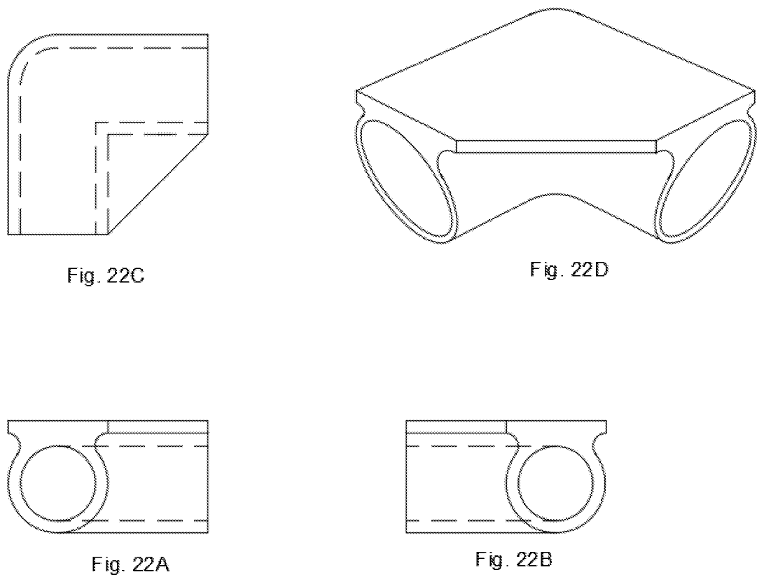

FIG. 23, 90′ With Upper and Small Outer Edge—This can be used for connecting PVC together for creating support for a lower shelf of a unit and can be used as a foot. This connector can also have a flat or circular outer surface. Figure A would be the Front view of the item, Figure B would be the Right-Side view of the item, Figure C would be the Top view of the item and Figure D will be the 3D view of the item.

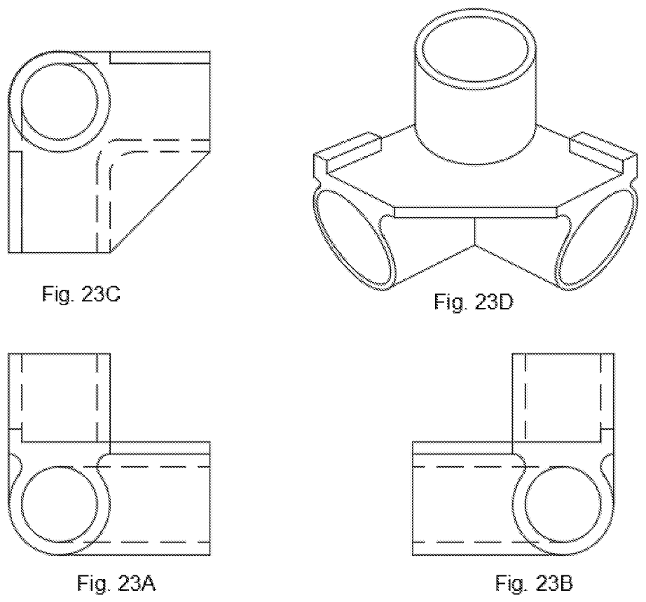

FIG. 24, 90′ With Upper and Long Aligned Outer Edge—This can be used for connecting

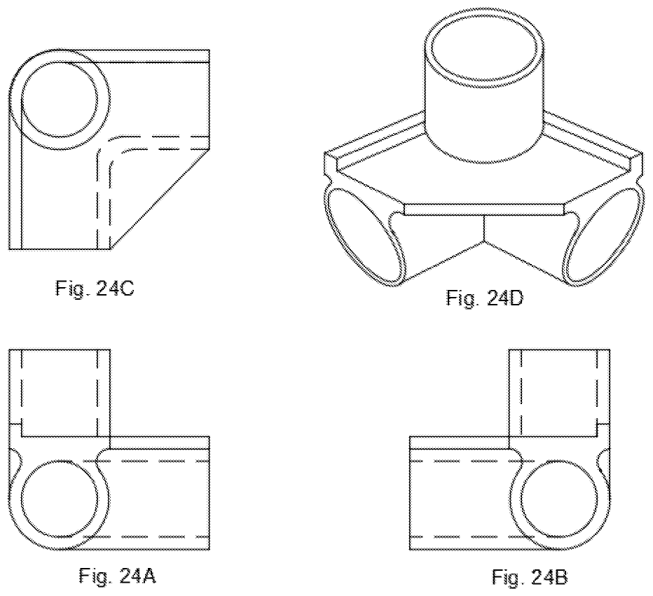

PVC together for creating support for a lower shelf of a unit and can be used as a foot. This connector can also have a flat or circular outer surface. Figure A would be the Front view of the item, Figure B would be the Right-Side view of the item, Figure C would be the Top view of the item and Figure D will be the 3D view of the item.

FIG. 25, 90′ With Upper—This can be used for connecting PVC together and creating a corner section or can be used as a foot for stabilization. Figure A would be the Front view of the item, Figure B would be the Right-Side view of the item, Figure C would be the Top view of the item and Figure D will be the 3D view of the item.

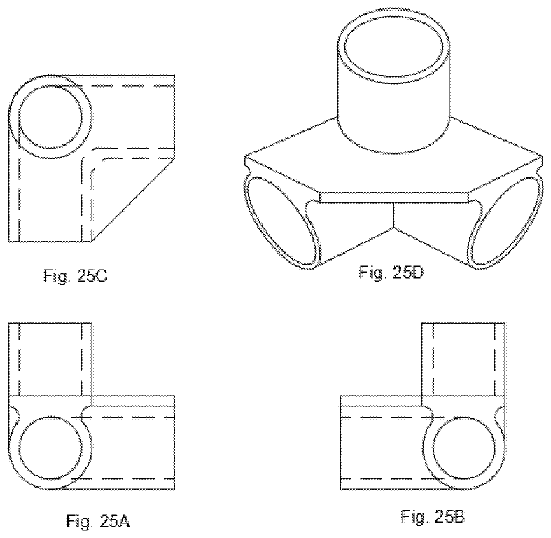

FIG. 26, 90′ w/Upper and Lower—This can be used for connecting PVC together and creating a corner section of a shelving unit with an upper and lower connector. An outer edge can also be used for the retaining of a shelf and can also have a flat or circular inner surface. Figure A would be the Front view of the item, Figure B would be the Right-Side view of the item, Figure C would be the Top view of the item and Figure D will be the 3D view of the item.

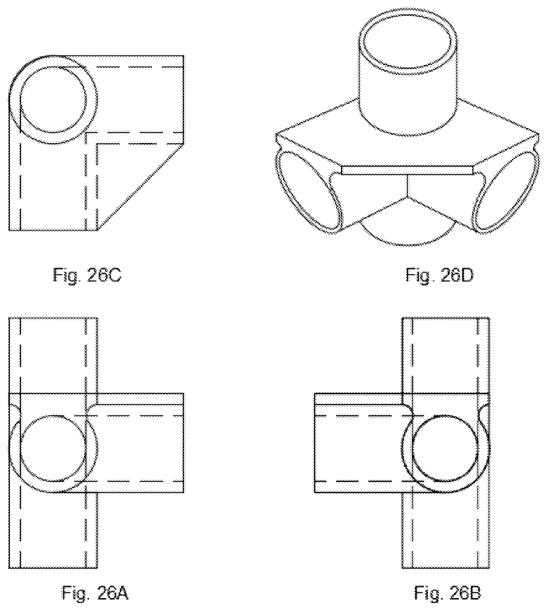

FIG. 27, 4 Way T—This can be used for connecting PVC together and creating a foot or an upper shelf for the unit. This connector can also have a flat or circular outer surface. Figure A would be the Front view of the item, Figure B would be the Right-Side view of the item, Figure C would be the Top view of the item and Figure D will be the 3D view of the item.

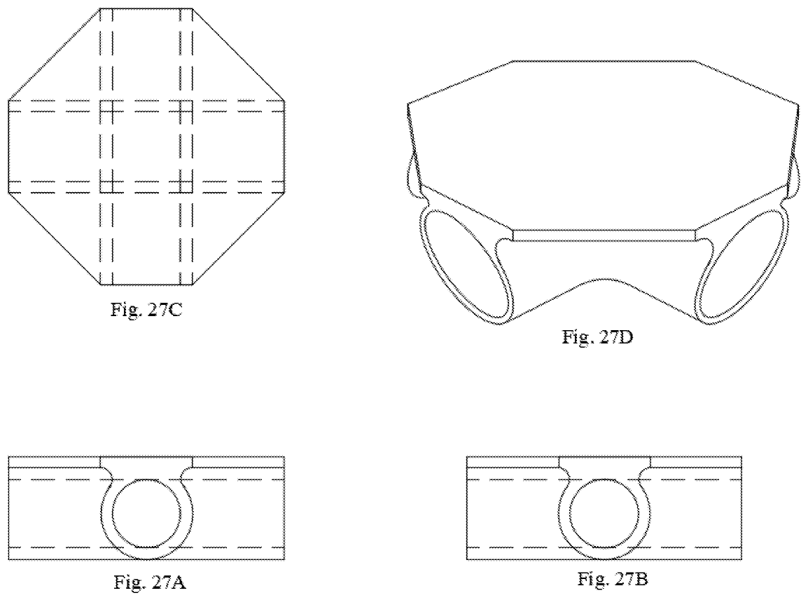

FIG. 28, 45′—Y—This is similar to FIG. 19 but has a different shape. Figure A would be the

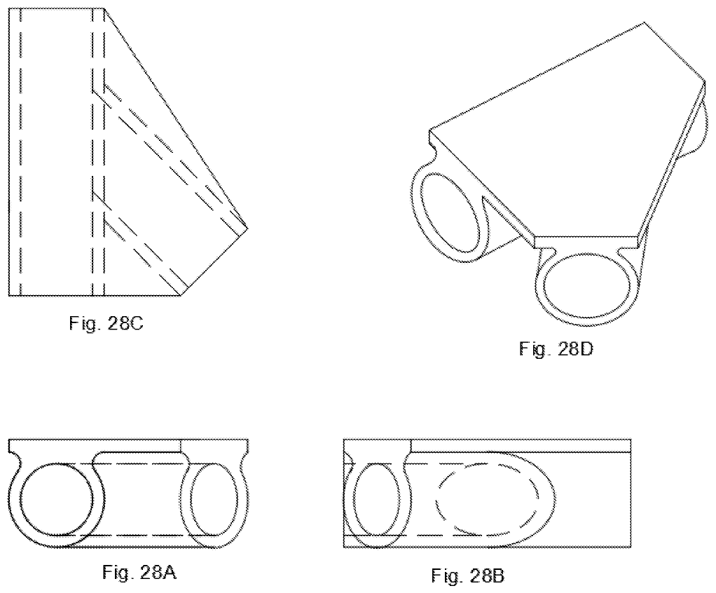

Front view of the item, Figure B would be the Right-Side view of the item, Figure C would be the Top view of the item and Figure D will be the 3D view of the item.

FIG. 29, 45′—This can be used in conjunction with any other connector to make the final design. Figure A would be the Front view of the item, Figure B would be the Right-Side view of the item, Figure C would be the Top view of the item and Figure D will be the 3D view of the item.

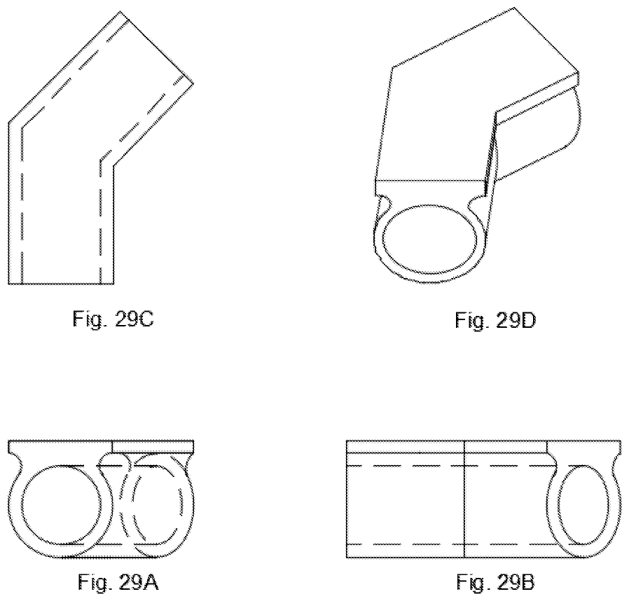

All corner connectors—if a circular effect is required, the angle of the corner connectors can go from 0′ to 360′, depending on the angle preferred.

1) (canceled)

2) (canceled)

3) (canceled)

4) (canceled)

5) (canceled)

6) (canceled)

7) (canceled)

8) (canceled)

9) (canceled)

10) (canceled)

11) In combination with a PVC pipe, these fittings can be used for building a variety of shelving units.

12) In combination with a PVC pipe, these connectors with upper/lower and horizontal connections can have a tapered edge for creating a smoother surface.

13) In combination with a PVC pipe, all Corner Connectors—If a Circular effect is required, the angle of the corner connectors can go from 0′ to 360′, depending on the angle preferred.
